(19) United States
(12) Patent Application Publication
(10) Pub. No.: US 2002/0075949 A1
(43) Pub. Date: Jun. 20, 2002

(54) Variable bandwidth discrete multi-tone (DMT) rate-adaptive asymmetric digital subscriber line (RADSL) transceiver

(76) Inventors: Raja Banerjea, Edison, NJ (US); Bahman Barazesh, Marlboro, NJ (US)

Correspondence Address: Farkas & Manelli pllc, 7th Floor, 2000 M Street, N.W., Washington, DC, 20036-3307, US

(21) Appl. No.: 09/736,159

(22) Filed: Dec. 14, 2000

(51) Int. Cl. H04B 1/38; H04L 5/16

(52) U.S. Cl. 375/222

(57) ABSTRACT

The present invention combines the inherent advantages of half-rate and full-rate DMT modulation schemes. A DMT transceiver of a DSL modem includes a variable bandwidth receiver filter which adjusts the bandwidth of the signal received by a DMT receiver. The variable bandwidth receiver filter may be analog or digital in design. The DMT transceiver further includes an AM radio signal detector and useful bandwidth detector which can detect the presence of AM radio interference (e.g., strong AM radio signals) on the service line. Then, either automatically or with user confirmation, the DMT transceiver adaptively adjusts its bandwidth from, e.g., a full-rate DMT mode to a half-rate DMT mode, or from using all sub-channels to using less than all available sub-channels, by changing the parameters of the variable bandwidth receiver filter, in accordance with the principles of the present invention. A highest number of sub-channel used may be transmitted to a corresponding DMT transceiver at the other end (e.g., at a central office).

### BACKGROUND OF THE INVENTION

1. Field of the Invention

This invention relates generally to digital subscriber line (DSL) solutions. More particularly, it relates to a method and technique for adapting a bandwidth of a discrete multi-tone (DMT) rate adaptive asymmetrical digital subscriber line (RADSL).

2. Background

Digital subscriber line (DSL) technology transforms inexpensive copper phone lines into high speed, high value data service lines. DSL refers to a group of digital data services which support data speeds from 128 Kbps to 8 Mbps over standard copper phone lines. The first true DSL was ISDN and while that service has become popular, the limited bandwidth options make it less appealing than the newer high speed alternatives that have been developed.

DSL was originally designed to allow regular phone services even in the event of power outages-in what is termed “lifeline POTs” or “Plain Old Telephone Service.” This feature is still available in the asymmetric DSL (ADSL) and rate adaptive DSL (RADSL) variations of DSL. In fact, with ADSL and RADSL, users get the benefits of using not only a single pair of wiring, but get both high speed digital data services and their regular lifeline telephone service over that wiring.

Traditional analog voice services require 300 Hz to 3,400 Hz of bandwidth 521 on a local loop of copper wiring (i.e., the telephone line) between traditional central office switches and customer premises, as shown in FIG. 4. These same wires are, however, capable of carrying information at much higher rates when modern digital signal processing technologies are used. The explosive growth in Internet access, as well as remote LAN access and telecommuting has resulted in a high demand for faster data services. DSL technologies utilize a bandwidth 523 of up to 1.2 MHz (over 300 times the bandwidth of an analog phone call) as shown in FIG. 5, and allows data speeds of over 8 Mbps.

As its name implies, ADSL transmits an asymmetric data stream, with up to 8 Mbps downstream bandwidth (to the subscriber) and only up to 1 Mbps upstream bandwidth.

While the asymmetry is somewhat dictated by the particular application, the reason for this asymmetry has less to do with transmission technology than with the telephone cabling. Twisted pair telephone wires are bundled together in large cables. Fifty pair to a cable is a typical configuration towards the subscriber, but cables coming out of a central office may have hundreds or even thousands of pairs bundled together. An individual line from a central office to a subscriber is spliced together from many cable sections as they fan out from the central office. Twisted pair wiring was designed to minimize the interference of signals from one cable to another, but the process is not perfect. Signals do interfere with one another as frequencies and the length of line increase. In fact, if you try to send symmetric signals in many pairs within a cable, you significantly limit the data rate and length of line that you can attain.

Asymmetric solutions are targeted primarily at individual Internet subscribers who receive more information than they send. Businesses typically host web servers, requiring high-speed Internet bandwidth in both directions.

Two line coding schemes are possible with ADSL: Discrete Multi-Tone (DMT) and Carrierless Amplitude and Phase (CAP) modulation. DMT is approved by ANSI's Working Group T1 E1.4 as an industry standard.

ADSL has two significant advantages. It is the fastest DSL technology that supports the maximum distance in the local loop. Moreover, it supports lifeline or Plain Old Telephone Service (POTS).

With ADSL, data and lifeline POTS are provided as independent channels on a single line. SDSL technologies require a separate voice line—two lines total—to provide both services. This is not a problem in most newer buildings which are usually wired for at least two lines, but ADSL does offer a significant edge in older houses and apartments served by a single line. These two advantages make ADSL the favored long-term solution among carriers and service providers addressing the consumer market.

With ADSL speeds, both upstream and downstream vary with distance. ADSL speeds can vary greatly based on a number of conditions. In areas where there is a large variance in the length of the local loop (distance from the subscriber to the central office), the gauge of the wire, and the condition of the line, it becomes difficult to determine what speeds should be provisioned over each line. It is for these reasons that Rate Adaptive ADSL (RADSL) was developed.

Rate Adaptive ADSL allows automatic, or provider specified, adjustment of the speed on the line. Rate Adaptive Asymmetric Digital Subscriber Line (RADSL) offers a downstream (from the central office or central site to residence) data rate of up to 8.0 Mbps and an upstream (from residence to the central office) speed to 1.0 Mbps. Some of the advantages of RADSL are reduced loop qualification efforts, maximized service coverage, a single product serves multiple applications, simplified deployment, reduced product inventory requirements, adaptability of data rate to changing loop conditions, the availability of bandwidth-based service offerings, and the simplification of service issues due to automatic rate adaptation.

FIG. 6 shows a typical RADSL configuration including a RADSL modem 400 at a subscriber's site. RADSL provides a solution most suitable for low-cost, high speed Internet applications.

Like ADSL, RADSL can use either Carrierless amplitude phase (CAPS) modulation, or discrete multitone (DMT) modulation. The primary difference between the RADSL-CAP and RADSL-DMT line cards is in the modulation technique used. The main difference between these two line coding methods is in determining the optimum speed between the central office and the residence/business over a single twisted pair of wire. CAP treats the entire frequency spectrum as a single channel and optimizes the data rate over that channel. DMT divides the bandwidth into sub-channels and optimizes the data rate for each sub-channel.

The relevant standards committees (i.e., ANSI and ETSI) have approved Discrete Multi-Tone (DMT) technology for implementing broadband copper local loops to the home, and this same technology can be used with any telephone grade twisted pair copper wiring. The DMT technique breaks up the available bandwidth into multiple sub-channels, and then modulates each band. Just as is done in CAP, the lower end of the spectrum is left alone for carrying the regular analog phone service. In ADSL DMT-systems, the downstream channels from 26 KHz to 1.2 MHz are divided into 256 4 KHz wide tones. The upstream channels spanning 26 KHz to 138 KHz frequencies are divided into 32 sub-channels 613, as shown in FIGS. 7 and 8. Each sub-channel is used as a carrier with bit and power allocations according to the signal to noise ratio characteristics of the sub-channel. Thus, the link transmission is optimized by running each of the sub-channels at best possible data rates.

In the realm of heavy digital subscriber line (DSL) solutions, there are situations where the interference level relative to the useful signal is such that after applying the programmable gain to the received signal, the analog-to-digital converter input is primarily dominated by interference.

Discrete Multi-tone (DMT) modulation is known to offer the advantage of selecting tones with best signal to noise ratios (SNR) and leaving out tones affected by interference. However, there are situations where the interference level relative to the useful signal is still such that after applying the programmable gain to the received signal, the analog-to-digital converter input is primarily dominated by the interference, thereby causing deterioration of receiver performance.

One of the major sources of interference for DMT systems is AM radio interference 599, as shown in FIG. 9. AM radio signals span from about 450 KHz or so up to 1.6 MHz.

There are typical situations where AM radio interference can be particularly detrimental to a modem's performance. For instance, telephone line loops having untwisted drop cable, unbalanced bridged taps, or unbalanced home wiring may cause susceptibility to AM interference. In this case, AM interference results in a strong interference signal in the modem receiver which cannot be totally eliminated by conventional common mode rejection filters.

Other examples include long telephone line loops with high insertion loss, and telephone lines picking up AM radio interference coupled after line insertion loss. In such cases, a high PGA gain is required before analog-to-digital conversion.

Other interference sources such as T1 crosstalk also tend to have higher spectral density at higher frequencies.

In a half-rate DMT system, the downstream band is limited to 554 MHz, which includes a small part of the AM band. In a full-rate DMT system, the downstream band is limited to 1.104 MHz of bandwidth, which includes the AM radio frequency band.

Since the AM radio frequency band starts from 450 MHz or so, a half-rate DMT system offers an inherent advantage. In particular, since a receive filter of a typical half-rate system eliminates AM radio interference before it is amplified, typical AM radio interference will tend not to dominate the analog-to-digital converter of a half-rate DMT modem.

### SUMMARY OF THE INVENTION

In accordance with the principles of the present invention, a discrete multi-tone modem device comprises an AM radio signal level detector, and a variable bandwidth receiver filter. A bandwidth of the variable bandwidth receiver filter is adjusted based on a level and/or a frequency of AM radio signals detected by the AM radio signal level detector.

A method of automatically adjusting a bandwidth of a DSL modem based on AM radio signal interference in accordance with another aspect of the present invention comprises detecting a level of AM radio signal in a received signal, and adjusting a bandwidth of a receiver based on an amount of AM radio signals detected in the received signal.

### BRIEF DESCRIPTION OF THE DRAWINGS

Features and advantages of the present invention will become apparent to those skilled in the art from the following description with reference to the drawings, in which:

FIG. 1 shows the relevant portion of a discrete multi-tone (DMT) transceiver including a variable bandwidth receiver filter, in accordance with the principles of the present invention.

FIG. 2 shows the DMT transceiver of FIG. 1 in more detail, including an AM radio signal detector and a useful bandwidth detector, in accordance with another embodiment of the present invention.

FIG. 3 depicts an exemplary digital implementation of a variable bandwidth receiver filter, placed after analog-to-digital (A/D) conversion in the digital domain, in accordance with the principles of the present invention.

FIG. 4 shows the bandwidth of traditional analog Plain Old Telephone Service (POTS), from 300 Hz to 3,400 Hz, on a local loop of copper wiring (i.e., the telephone line) between traditional central office switches and customer premises.

FIG. 5 shows typical DSL bandwidth usage of up to 1.2 MHz.

FIG. 6 shows a typical RADSL configuration including a RADSL modem at a subscriber's site.

FIG. 7 shows the bandwidth utilized by RADSL Carrierless Amplitude Phase (CAP) modulation dividing the spectrum into a voice band, an upstream communications band, and a downstream communications band.

FIG. 8 shows the bandwidth utilized by RADSL-discrete multi-tone (DMT) techniques dividing the spectrum into upstream channels spanning 26 KHz to 138 KHz frequencies.

FIG. 9 shows AM radio interference as a major source of interference for DMT systems.

### DETAILED DESCRIPTION OF ILLUSTRATIVE EMBODIMENTS

A heavy (full-rate) DMT system offers higher data rates than a lite (half-rate) DMT system, since a heavy DMT system uses more than twice as many tones than a corresponding half-rate DMT system. However, a lite DMT system offers the advantage of being more robust in the presence of AM radio interference and thus can achieve a larger reach as compared to a heavy DMT system in light of such interference. The DMT transceiver in accordance with the principles of the present invention can adaptively and automatically switch a DMT transceiver from a heavy DMT system to a lite DMT system, and back again, based on a current level of AM interference.

The present invention offers the inherent advantages of half-rate and full-rate DMT modulation schemes by providing a DMT transceiver which adaptively adjusts itself based on a detected presence of AM radio signal interference.

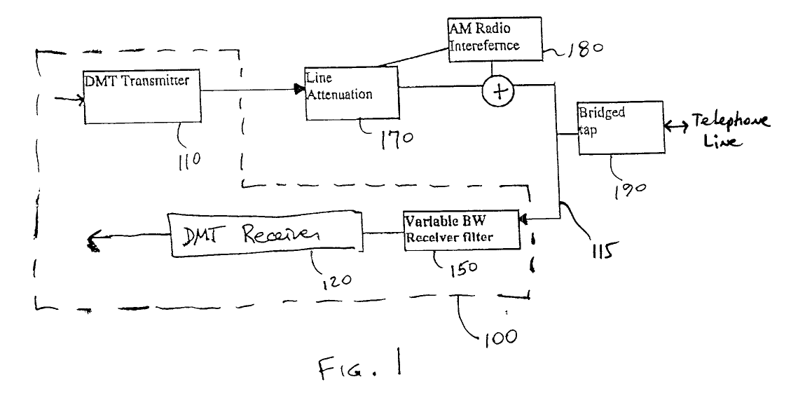

FIG. 1 shows the relevant portion of a discrete multi-tone (DMT) transceiver 100 including a DMT transmitter 110, a DMT receiver 120, and a variable bandwidth receiver filter 150, in accordance with the principles of the present invention.

In particular, as shown in FIG. 1, a DMT transceiver 100 utilizes a service line 115 to a bridged tap 190 for connecting to the telephone line. An AM radio signal interference block 180 shows that the AM radio signal is added to the service line 115, and a line attenuation block 170 shows that the transmitted signal from transmitter 110 is attenuated.

In accordance with the principles of the present invention, the DMT transceiver 100 includes a DMT receiver 120 which has its bandwidth adjusted using a variable bandwidth receiver filter 150.

The bandwidth filter 150 can adjust the bandwidth between fixed bandwidths, e.g., between a full-rate and a half-rate. Alternatively, the bandwidth filter 150 can adjust the receive bandwidth incrementally, e.g., to allow use of any number of available sub-channels (e.g., from 1 to 256 sub-channels).

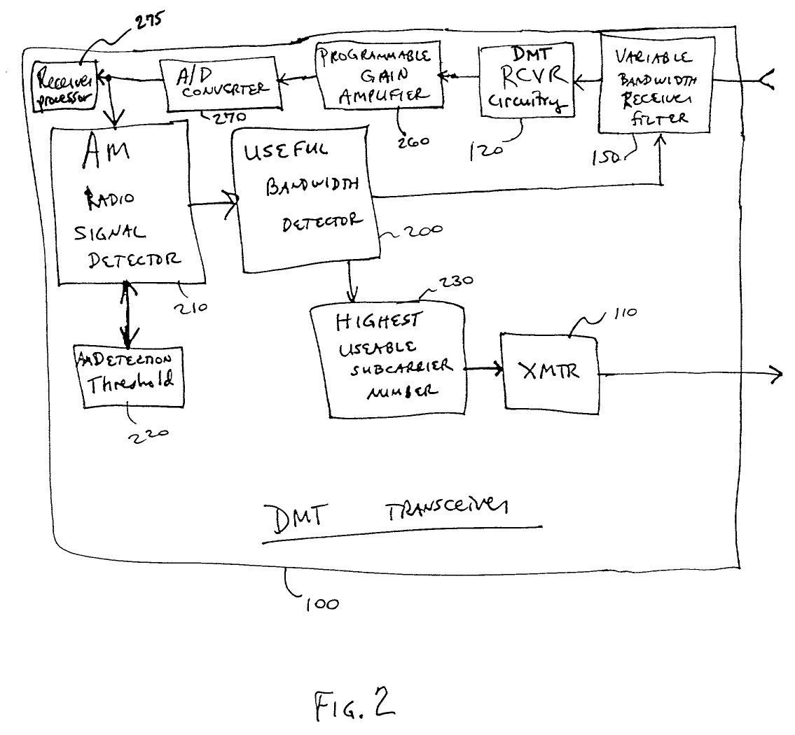

FIG. 2 shows the DMT transceiver of FIG. 1 in more detail, including an AM radio signal detector 210 and a useful bandwidth detector 200, in accordance with another embodiment of the present invention.

FIG. 2 also shows that the DMT transceiver 100 can include a programmable gain amplifier 260 following the DMT receiver 120. The gain of the programmable gain amplifier 260 may be controlled by a suitable processor, controller or logic.

An analog-to-digital (A/D) converter 270 follows the programmable gain amplifier 260, and provides digitized samples of the received signal to a suitable receiver processor 275 as well as to an AM radio signal detector 210.

The AM radio signal detector 210 monitors the AM radio band (i.e., from 554 KHz to 1.104 MHz) and appropriately signals when AM signals above a given threshold level that can be harmful to the DMT receiver performance. The AM radio signal detector 210 measures an appropriate parameter relating to AM radio signals contained in the received signal, based on a predetermined AM detection threshold 220.

The predetermined AM detection threshold 220 may be pre-configured or factory pre-set by a manufacturer, set by a technician when initially installing the DMT modem, selectively configured by an installer or subscriber using, e.g., a suitable user interface configuration program, or even adaptively updated automatically by the AM radio signal detector 210.

The AM detection threshold level 220 may relate to any appropriate parameter of AM signal interference. For instance, the bandwidth of the variable bandwidth receiver filter 150 may be reduced when the AM radio signal level detector 210 detects AM radio signal energy in excess of the AM detection threshold level 220. Alternatively, the peak amplitude of the AM radio signals may be determined and compared to an appropriate peak amplitude threshold level. Other parameters may be determined, e.g., root mean square (RMS) and used to determine the presence of AM radio signals which likely will or may interfere with DSL operation over the appropriate service line.

The presence of actually or potentially interfering AM radio signals is provided to the useful bandwidth detector 200, which adjusts the variable bandwidth receiver filter 150 accordingly.

In another embodiment, the useful bandwidth detector 200 may determine a maximum useable subcarrier number from a plurality of available subcarriers, and provide the same to a device communicating with the DMT modem. In this way, communications can be restricted to less than all available subcarriers based on an amount of AM radio signal interference actually received by the DMT transceiver 100.

The useful bandwidth detector 200 determines an appropriate adjustment to the variable bandwidth receiver filter 150 based on the detected presence and/or level of AM radio signals which actually or potentially could interfere with DMT communications. For instance, the useful bandwidth detector 200 may select either full-rate (i.e., all of the multi-tones) or half-rate (i.e., half of the multi-tones) DMT transmissions by appropriate settings in the variable bandwidth receiver filter 150.

Alternatively, the useful bandwidth detector 200 may provide greater resolution by including a highest useable subcarrier module 230 which determines a maximum number of sub-channels which may be used within bandwidth not showing significant AM interference, which is then transmitted to, e.g., the modem in the network system or central office for subsequent downstream training signals.

Thus, either automatically or with user confirmation, the DMT transceiver 100 adaptively adjusts its bandwidth from, e.g., a full-rate DMT mode to a half-rate DMT mode by changing the parameters of the variable bandwidth receiver filter 150. The variable bandwidth receiver filter may be analog or digital in design.

The maximum useable bandwidth determined by the useful bandwidth detector 200 may be communicated to a network system provider (e.g., to the central office), and future DMT transmissions between the network modem (ATU-C) and the DMT transceiver 100 will then be handed using only the newly ‘cleared’ bandwidth.

The bandwidth of the variable bandwidth receiver filter 150 may be periodically adjusted either during use, or between uses, to adaptively adjust the DMT transceiver 100 to changing levels and frequencies of AM signals in the environment.

In an analog implementation, the variable bandwidth receiver filter 150 may be based on, e.g., switched receiver filter components. In such an analog implementation, when AM radio signal interference is detected, bandwidth parameters of the variable bandwidth receiver filter 150 are appropriately changed to allow a receive signal containing only one or more useable portions of the DSL bandwidth to reach the receiver 120.

The invention provides for a full-rate DMT transceiver system which supports an adaptive bandwidth receiver filter 150 to offer the high performance of a full-rate DMT system while at the same time offering the robustness of a half-rate DMT system when necessary, i.e., when in the presence of AM radio and/or other interference signals.

Other advantages such as ease of installation and splitter-less operation have also been attributed to the use of a lite DMT system. In accordance with the principles of the present invention, such methods can also be applied to the use of a system capable of full-rate DMT modulation.

Detection of the presence of AM radio interference signals (e.g., strong AM radio signals) may be accomplished with quiet line (no DMT signal present) measurements or in a half-duplex training stage of DMT startup. At this point, the DMT transceiver 100 determines the operable bandwidth of the receive filter.

The operable bandwidth of the DMT transceiver 100 may be determined to be a particular value, e.g., either the full number of available tones, or half of the available tones or other subset of the full number of available tones.

When the operable bandwidth of the DMT transceiver 100 is determined to support only half of the available tones (or at least not substantially all of the available tones), the DMT transceiver 100 is automatically placed (and/or with user confirmation) into a half-band mode.

Then, the DMT transceiver 100 moves to the next stage of its startup associated with a half-rate mode, e.g., as described in a co-owned U.S. patent application Ser. No. 09/364,411, entitled “Low-Complexity DMT Transceiver” filed Jul. 30, 1999 by Banerjea, et al. This patent application is hereby explicitly incorporated herein by reference.

There are also other situations where the DMT transceiver 100 may decide to use a lower bandwidth. One such case is the long loop case, where the 554 KHz to 1.108 KHz band has suffered high insertion loss and does not have sufficient signal to noise ratio to be used for data transmission. In such a case, a lower bandwidth system offers the advantage of suppressing out of energy interference and noise prior to applying the received signal to the programmable gain amplifier 260. This results in higher gain and higher resolution of the analog-to-digital converter 270, and hence higher signal to noise ratio.

The present invention provides the capability to achieve the high connect rates of a full-rate DMT system when line conditions are favorable (e.g., in the absence of strong AM radio signal interference) and/or moderate loop attenuation. The present invention also provides the robustness of a half-rate DMT system by removing any AM interference in the analog domain, preferably before reaching a gain amplifier and/or analog-to-digital converter. Thus, AM radio interference won't dominate the input to the ADC.

When operating on a long loop (i.e., where the higher tones are not useful), use of only a fraction (e.g., half) of the presumed bandwidth allows higher gain in the programmable gain amplifier 260, and hence reduces the required resolution and cost of the analog-to-digital converter 270.

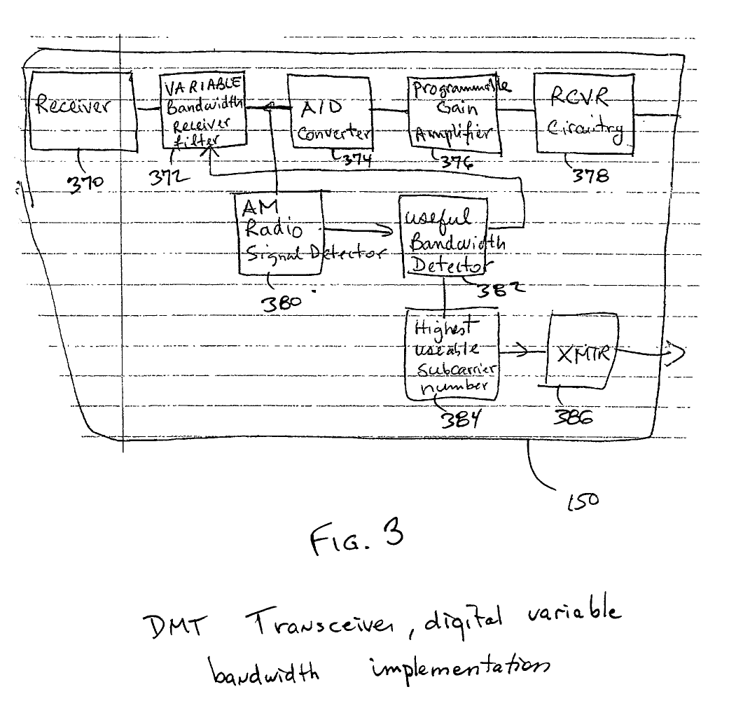

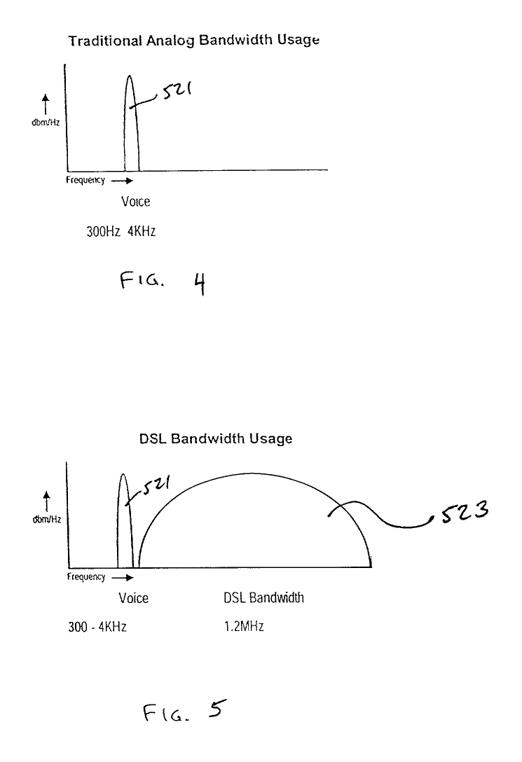

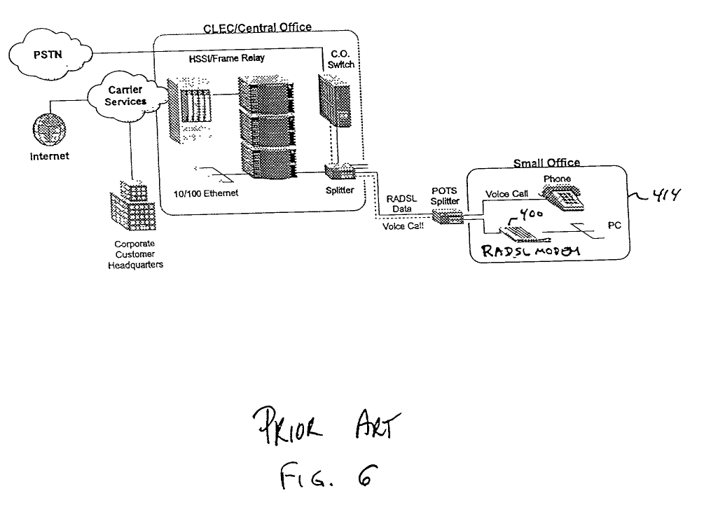

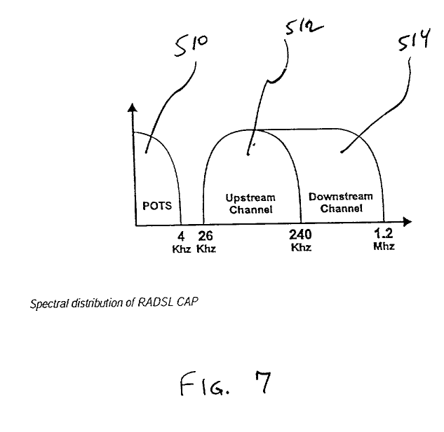

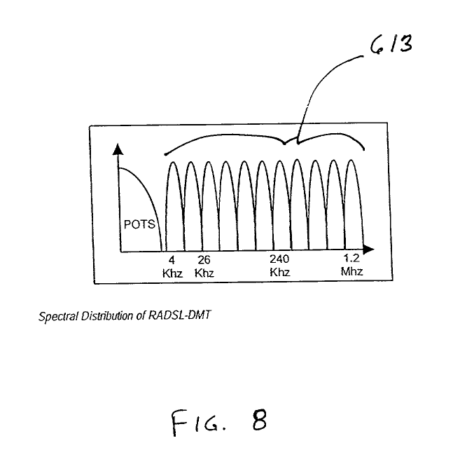

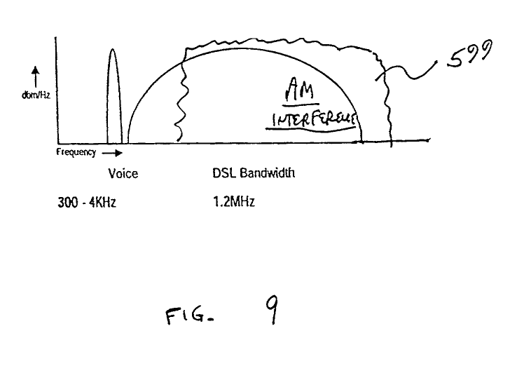

FIG. 3 depicts an exemplary digital implementation of a variable bandwidth receiver filter 150, in accordance with the principles of the present invention.

In particular, as shown in FIG. 3, the variable bandwidth receiver filter 150 is placed after analog-to-digital (A/D) conversion 374 in the digital domain, in accordance with the principles of the present invention.

The digital implementation includes receiver circuitry 378, followed by a programmable gain amplifier 376, an A/D converter 374, the digital variable bandwidth receiver filter 372, and the receiver 370. An AM radio signal detector receives a signal from the A/D converter 374, and passes detection information to a useful bandwidth detector 382, which in turn controls the bandwidth of the variable bandwidth receiver filter 372. The useful bandwidth detector 382 also provides information to a highest useable subcarrier number 384, which in turn controls a relevant transmitter 386.

Depending upon the particular A/D structure, the variable bandwidth receiver filter 150 may be integrated into an interpolation filter of the relevant A/D converter.

In the disclosed embodiment, the customer's ATU-R modem may determine and select the useful bandwidth at any particular time, without requiring intervention by the corresponding ATU-C DMT modem.

The accuracy and thus the reach of a customer's DMT modem can be enhanced by adaptively and automatically adjusting the bandwidth of the half-rate modem.

Implementation of the present invention can result in the absence of tone usage and thus energy in the higher tones of a full-rate DMT modem when operating in a half-rate mode.

While the invention has been described with reference to the exemplary embodiments thereof, those skilled in the art will be able to make various modifications to the described embodiments of the invention without departing from the true spirit and scope of the invention.

What is claimed is:

1. A discrete multi-tone modem device, comprising:
an AM radio signal level detector; and
a variable bandwidth receiver filter;
wherein a bandwidth of said variable bandwidth receiver filter is adjusted based on at least one of a level and a frequency of AM radio signals detected by said AM radio signal level detector.

2. The discrete multi-tone modem device according to claim 1, further comprising:
an AM detection threshold level in communication with said AM radio signal level detector;
wherein said bandwidth of said variable bandwidth receiver filter is reduced when said AM radio signal level detector detects AM radio signal energy in excess of said AM detection threshold level.

3. The discrete multi-tone modem device according to claim 1, wherein:
said modem device is a rate adaptive digital subscriber line device.

4. The discrete multi-tone modem device according to claim 1, wherein:
said variable bandwidth receiver filter is a digital filter.

5. The discrete multi-tone modem device according to claim 1, wherein:
said digital filter is a digital signal processor.

6. The discrete multi-tone modem device according to claim 1, wherein said variable bandwidth digital filter comprises:
a plurality of switched analog components to provide a corresponding plurality of filter bandwidths.

7. The discrete multi-tone modem device according to claim 1, further comprising:
a useful bandwidth detector to determine a highest useable subcarrier number of a plurality of available subcarriers.

8. The discrete multi-tone modem device according to claim 7, wherein:
said plurality of available subcarriers is at least 256 subcarriers.

9. A method of automatically adjusting a bandwidth of a DSL modem based on AM radio signal interference, comprising:
detecting a level of AM radio signal in a received signal; and
adjusting a bandwidth of a receiver based on an amount of AM radio signals detected in said received signal.

10. The method of automatically adjusting a bandwidth of a DSL modem based on AM radio signal interference according to claim 9, further comprising:
determining a useful amount of available bandwidth free of significant AM signal interference.

11. The method of automatically adjusting a bandwidth of a DSL modem based on AM radio signal interference according to claim 10, further comprising:
transmitting a highest useable subcarrier number from said DSL modem based on said amount of AM radio signals detected in said received signal.

12. Apparatus for automatically adjusting a bandwidth of a DSL modem based on AM radio signal interference, comprising:
means for detecting a level of AM radio signal in a received signal; and
means for adjusting a bandwidth of a receiver based on an amount of AM radio signals detected in said received signal.

13. The apparatus for automatically adjusting a bandwidth of a DSL modem based on AM radio signal interference according to claim 12, further comprising:
means for determining a useful amount of available bandwidth free of significant AM signal interference.

14. The apparatus for automatically adjusting a bandwidth of a DSL modem based on AM radio signal interference according to claim 13, further comprising:
means for transmitting a highest useable subcarrier number from said DSL modem based on said amount of AM radio signals detected in said received signal.
